(19) United States
(12) Patent Application Publication
(10) Pub. No.: US 2018/0267959 A1
(43) Pub. Date: Sep. 20, 2018

(54) SYSTEM AND METHOD OF CREATING A DYNAMIC SOCIAL VIBE OF A USER BY PROCESSING PERSONALITY RELATED WORDS

(71) Applicant: Neha Lal, Gurgaon (IN)

(72) Inventor: Neha Lal, Gurgaon (IN)

(21) Appl. No.: 15/641,662

(22) Filed: Jul. 5, 2017

(30) Foreign Application Priority Data
Mar. 17, 2017 (IN) 201711009464

(51) Int. Cl. G06F 17/27; H04L 29/08; H04L 12/58

(52) U.S. Cl. CPC G06F 17/2785; H04L 51/32; H04L 67/306

(57) ABSTRACT

An embodiment herein provides a method for determining a dynamic social vibe of a user based on personality related words attributed to the user by responders. The method includes the step of: (a) obtaining responder provided personality related words that are chosen from appraised personality related words by the responders for the user; (b) converting each of the responder provided personality related words into a vector form corresponding to the predefined dimensions; (c) determining user personality related words that describe a vibe of the user based on a vector addition of the vector form of each of the responder provided personality related words across the predefined dimensions; and (d) creating and visualizing the dynamic social vibe that indicates the vibe projected by the user across the predefined dimensions based on the norm value and the standard deviation corresponding to the predefined dimensions.

### CROSS-REFERENCE TO RELATED APPLICATIONS

This application claims priority to Indian patent application no. 201711009464 filed on Mar. 17, 2017, the complete disclosure of which, in its entirely, is herein incorporated by reference.

### BACKGROUND

### Technical Field

The embodiments herein generally relate to creation of a dynamic social vibe that describes a personality of a user, and more particularly, to a system and method of creating the dynamic social vibe of the user by processing personality related words attributed to the user obtained from responders.

### Description of the Related Art

A number of social networks ranging from chat platforms to full-fledged networking are present in the market. The basic aim of the social networks is to try and remain in touch and get various insights into what your friends or family would be doing. Most of them have photo sharing and or some form of video sharing and rating as well. However, none of the social network/media captures how the world thinks about you in the sense of how you behave and act, that is, in term of your overall personality. People always talk about others in terms of describing words or adjectives. When a person uses a word to describe an attribute in another person's personality, his/her meaning may differ than others who are using the same word to describe the same attribute, because of differences in intrinsic cognitive biases and other contextual factors. Hence, the meaning of a ‘good’ vacation for an introvert person may entirely be different from the meaning of a ‘good’ vacation for an extrovert person. Thus, it is imperative to understand the biases impacting the appraisal of any attribute. Therefore, there is a need for a solution to the difficulties inherent in determination of the personality descriptors about the person using describing words or adjectives.

### SUMMARY

In view of the foregoing, an embodiment herein provides a method for determining a dynamic social vibe of a user based on personality related words attributed to the user by responders. The method includes the step of: (i) accessing a probability space of appraised personality related words, wherein the appraised personality related words are created by an appraisal process. The appraisal process includes the step of: (a) storing chosen words that describes personality of people in general; (b) obtaining ratings for the chosen words from appraisers across a scale between two opposing features for predefined dimensions; (c) determining a central tendency value that describes a typical normalized value for each of the chosen words by a projection of each of the chosen words across the scale between two opposing features for the predefined dimensions in the probability space; (d) determining a dispersion value that measures dispersion of each of the chosen words in the probability space based on the projection of each of the chosen words across the scale between two opposing features for the predefined dimensions; (e) generating a probability space expression for each of the personality related words as the probability space represented by an union of each of the central tendency value and the dispersion value of the chosen words provided by the appraisers on each of the predefined dimensions; and (f) determining the appraised personality related words that describe dynamic attributes of the user on the probability space based on the probability space expression.

The method further includes the step of: (ii) obtaining responder provided personality related words that are chosen from the appraised personality related words by the responders for the user; and (iii) determining the dynamic social vibe of the user by a vibe process. The vibe process includes the step of: (g) converting each of the responder provided personality related words into a vector form corresponding to the predefined dimensions; (h) determining a norm value that measures a standard variation for each of the predefined dimensions corresponding to each of the responder provided personality related words; (i) generating a personality expression for each of the responder provided personality related words using the vector form of the norm value and the standard deviation across each of the predefined dimensions; (j) determining user personality related words that describe a vibe of the user based on a vector addition of the vector form of each of responder provided personality related words across all the predefined dimensions; and (k) creating and visualizing the dynamic social vibe that indicates the vibe projected by the user across the predefined dimensions based on the norm value and the standard deviation corresponding to the dimensions.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of a dynamic social vibe creation system that creates a dynamic social vibe for a user based on personality related words attributed to the user obtained from responders according to an embodiment herein;

FIG. 2 illustrates an exploded view of the appraisal server of FIG. 1 according to an embodiment herein;

FIG. 3 illustrates an exploded view of the dynamic social vibe creation system of FIG. 1 according to an embodiment herein;

FIG. 4A illustrates an user interface view of the dynamic social vibe creation system of FIG. 1 according to a first embodiment herein;

FIG. 4B illustrates an user interface view of the dynamic social vibe creation system of FIG. 1 according to a second embodiment herein;

FIG. 4C illustrates an user interface view of the dynamic social vibe creation system of FIG. 1 according to a third embodiment herein;

FIG. 5 illustrates an user interface view of the dynamic social vibe of FIG. 1 according to an embodiment herein;

FIG. 6 illustrates an exemplary view of the dynamic social vibe creation system of FIG. 1 according to an embodiment herein;

FIGS. 7A and 7B are flow diagrams that illustrate a method of determining the dynamic social vibe of the user based on personality related words attributed to the user by responders of FIG. 1 according to an embodiment herein; and

FIG. 8 illustrates a system view of overall technical and cloud architecture of the appraisal, video editing and app servers that are used to determine and publish the dynamic social vibe of FIG. 1 according to the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

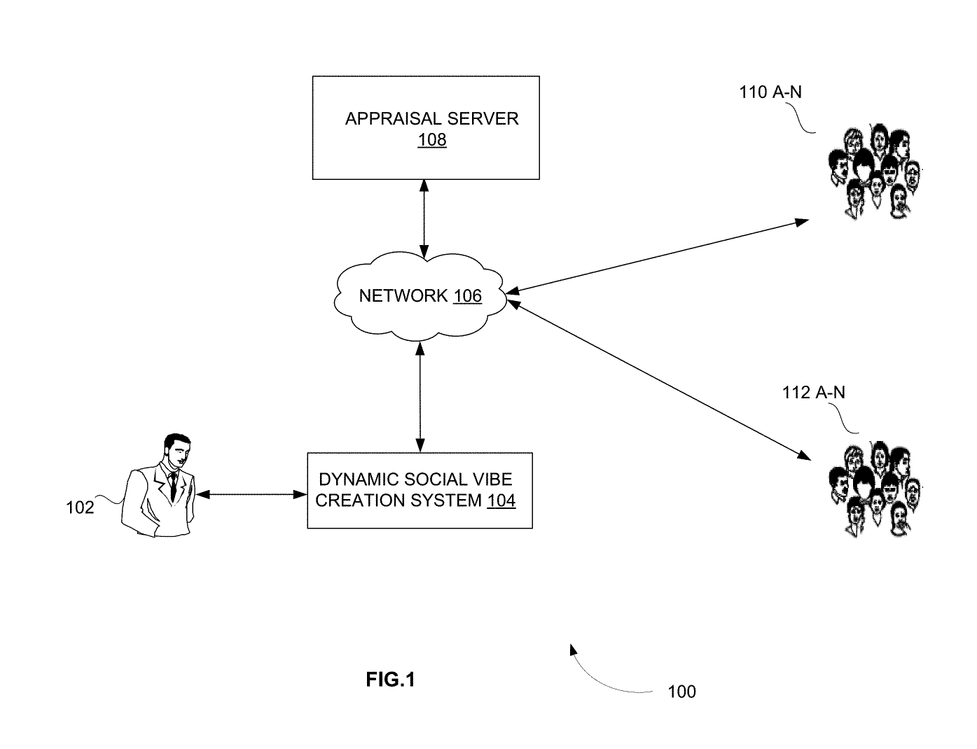

As mentioned, there remains a need for a system and method of creating the dynamic social vibe of the user by processing personality related words from responders for the user. Referring now to the drawings, and more particularly to FIGS. 1 through 8, where similar reference characters denote corresponding features consistently throughout the figures, preferred embodiments are shown.

A user may be a person who is getting evaluated for a social vibe. Responders may be the persons who provide personality related words that are analyzed for the user. Appraisers may be the persons who maps the personality related words with predefined dimensions that are used to analyze the personality related words. Central tendency is the most likely value of a spread of values in a probability space. Dispersion is an expression of the variation of the spread of value in the probability space. A dynamic social vibe is a pictorial depiction of the user personality.

FIG. 1 illustrates a system view of a dynamic social vibe creation system 104 that creates a dynamic social vibe for a user 102 based on personality related words attributed to the user 102 obtained from responders 112A-N according to an embodiment herein. The user 102 interacts with the dynamic social vibe creation system 104 to capture a video. The user 102 may be a person who is getting evaluated for the dynamic social vibe. Alternatively, the user 102 may access the video from a website or a social medium through a network 106. The video may include one or more segments. The one or more segments may be a name segment, a location segment, a passion segment, a profession segment, and the like. In another embodiment, the user 102 modifies the video by various editing features that are stored in the dynamic social vibe creation system 104. The video may be a thirty seconds video. The responders 112A-N may provide their personality related words to a video of the user 102. The responders 112A-N may be the persons who provide a personality related words that are analyzed for the user 102. In one embodiment, the responders 112A-N select their personality related words from appraised personality related words that are appraised in the appraisal server 108 by the appraisers 110A-N. The appraisers 110A-N may be the persons who maps the personality related words with predefined dimensions that are used to analyze the personality related words.

In another embodiment, the dynamic social vibe creation system 104 (a) obtains the responders provided personality related words that are chosen from the appraised personality related words by the responders 112A-N for the user 102, (b) converts each of the responder provided personality related words into a vector form corresponding to predefined dimensions, (c) determines a norm value that measures a standard variation for each of the dimensions corresponding to each of the responder provided personality related words, (d) generates a personality expression for each of the responder provided personality related words by the vector form of the norm value and the standard deviation across each of the predefined dimensions, (e) determines user personality related words that describe a vibe of the user 102 based on a vector addition of the vector form of each of the responder provided personality related words across the predefined dimensions, and (f) creates and visualizes the dynamic social vibe that indicates the vibe projected by the user 102 across the predefined dimensions based on the norm value and the standard deviation corresponding to the predefined dimensions.

In one embodiment, the dynamic social vibe creation system 104 creates the dynamic social vibe by processing the responders provided personality related words received from subsets of the responders 112A-N. In another embodiment, the dynamic social vibe creation system 104 visualizes the dynamic social vibe along with filters corresponding to the subsets of the responders 112A-N. The subsets may be but it is not limited to a family, friends, colleagues, acquaintances, unknowns and the like. The dynamic social vibe creation system 104 shows the dynamic social vibe by selecting one of the filters. The filters may be but it is not limited to only family, only friends, only colleagues, only acquaintances, only unknowns, show all, show only my self-assessment and the like. The dynamic social vibe is a pictorial depiction of the user 102 personality. In one embodiment, the dynamic social vibe is a measurement of the user 102 personality as the probability space across the predefined dimensions of conceptual understanding.

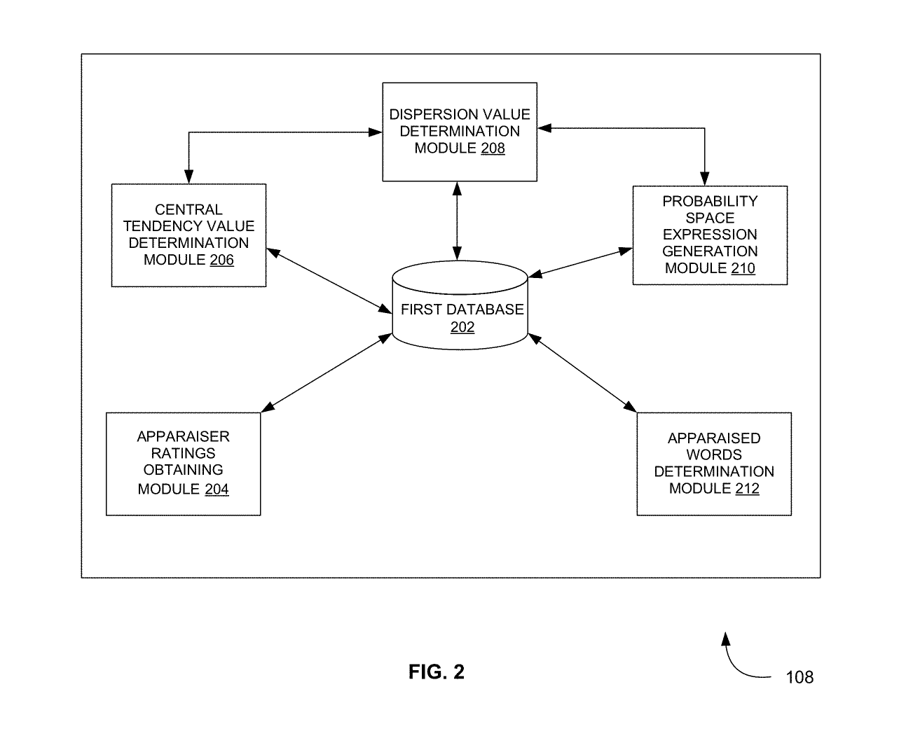

FIG. 2 illustrates an exploded view of the appraisal server 108 of FIG. 1 according to a first embodiment herein. The appraisal server 108 includes a first database 202, an appraiser ratings obtaining module 204, a central tendency value determination module 206, a dispersion value determination module 208, a probability space expression generation module 210, and an appraised words determination module 212. The appraisal server 108 further includes an actual meaning of word determination module, a context meaning of word determination module, a metaphorical meaning of word determination module, and an expansiveness meaning of word determination module. The actual meaning of word determination module determines an actual meaning for each of chosen words in many countries based on a cultural factor. For example, “Communal” means ‘belonging to a community’ when used in the United States. However, it means ‘leading to disharmony among different communities’ when used in South East Asia. The context meaning of word determination module determines a context meaning for each of the chosen words based on a context factor. For example, “Schedule” means ‘the list of things to be done’, but when used in context of ‘caste’ it means ‘a list of castes that have been given special privileges’. The metaphorical meaning of word determination module determines a metaphorical expression for each of the chosen words based on a metaphorical factor. For example, “magenta” is almost always understood as a color. However, “orange” can be seen as a color and also as a fruit. The expansiveness meaning of word determination module determines an expansiveness meaning for each of the chosen words based on an expansiveness factor. For example, “cool” means a large range of similar concepts “Confident” which has a much tighter meaning of the cool.

The appraiser ratings obtaining module 204 obtains ratings for the chosen words from the appraisers 110A-N across a scale between two opposing features for the predefined dimensions. For example, each of the appraisers 110A-N rates the chosen words across the scale (e.g., −5 to 0 and 0 to 5) between the two opposing features (e.g. people-oriented to task-oriented) for the predefined dimensions (e.g. choice dimension). The central tendency value determination module 206 determines a central tendency value (e.g. a most likely value of a spread of values in a probability space) that describes a typical normalized value for each of the chosen words by a projection of each of the chosen words across the scale between the two opposing features for the predefined dimensions in the probability space. The dispersion value determination module 208 determines a dispersion value (e.g. an expression of the variation of the spread of values in the probability space) that measures dispersion of each of the chosen words in the probability space based on the projection of each of the chosen words across the scale between the two opposing features for the predefined dimensions. The probability space expression generating module 210 generates a probability space expression for each of the personality related words as the probability space represented by a union of each of the central tendency value and the dispersion value of the chosen words provided by the appraisers 110A-N on each of the predefined dimensions. The appraised words determination module 212 determines the appraised personality related words that describe dynamic attributes of the user 102 on the probability space based on the probability space expression.

For example, each of the appraised words are expressed as follow, wordⱼ=∪ᵢ wordⱼⁱ={(μ_{j,1}σ_{j,1}), (μ_{j,2}σ_{j,2}) . . . (μ_{j,N}σ_{j,N})}, wherein μⱼ is the central tendency value, σⱼ is the dispersion value, and ∪ᵢ wordⱼⁱ is union. A definition of each of the chosen words may vary by each of the appraisers 110A-N. The central tendency value determination module 206 determines the central tendency value (e.g. μ_{j,1-N}) for each of the chosen words from each of the appraisers 110A-N. The dispersion value determination module 208 determines the dispersion value (e.g. σ_{j,1-N}) for each of the chosen words from each of the appraisers 110A-N. The probability space expression generating module 210 aggregates each of the central tendency value and each of the dispersion value to determine union (e.g. ∪ᵢ wordⱼⁱ) of the each of the chosen words. In one embodiment, the appraised words determination module 212 determines each of the appraised words corresponding to the union.

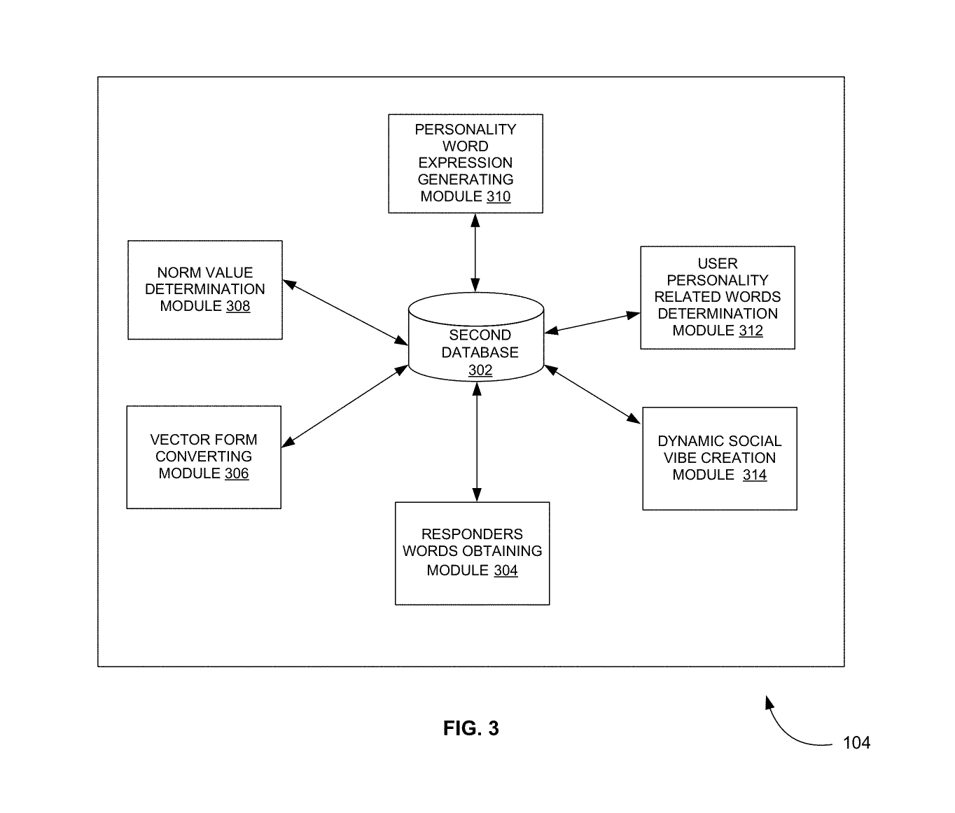

With reference to FIG. 2, FIG. 3 illustrates an exploded view of the dynamic social vibe creation system 104 of FIG. 1 according to an embodiment herein. The dynamic social vibe creation system 104 includes a second database 302, a responders words obtaining module 304, a vector form converting module 306, a norm value determination module 308, a personality word expression generating module 310, a user personality related words determination module 312, and a dynamic social vibe creation module 314.

The responders words obtaining module 304 obtains the responders provided personality related words that are chosen from the appraised personality related words by the responders 112A-N for the user 102. The vector form converting module 306 converts each of the responders provided personality related words into a vector form corresponding to the predefined dimensions. The norm value determination module 308 determines a norm value that measures the standard variation for each of the predefined dimensions corresponding to each of the responders provided personality related words. The personality word expression generating module 310 generates a personality expression for each of the responders provided personality related words by the vector form of the norm value and the standard deviation across each of the predefined dimensions. For example, the personality expression of the user 102 is expressed as Personalityₖⁱ=Σₗ₌₁^{M}β_{k,l}ⁱ{(μ_{l,1}σ_{l,1}), (μ_{l,2}σ_{l,2}) . . . (μ_{l,N}σ_{l,N})}.

The user personality related words determination module 312 determines user personality related words that describe a vibe of the user 102 based on the vector addition of the vector form of each of the responder provided personality related words across the predefined dimensions. The dynamic social vibe creation module 314 creates the dynamic social vibe that indicates the vibe projected by the user 102 across the predefined dimensions based on the norm value corresponding to the predefined dimensions.

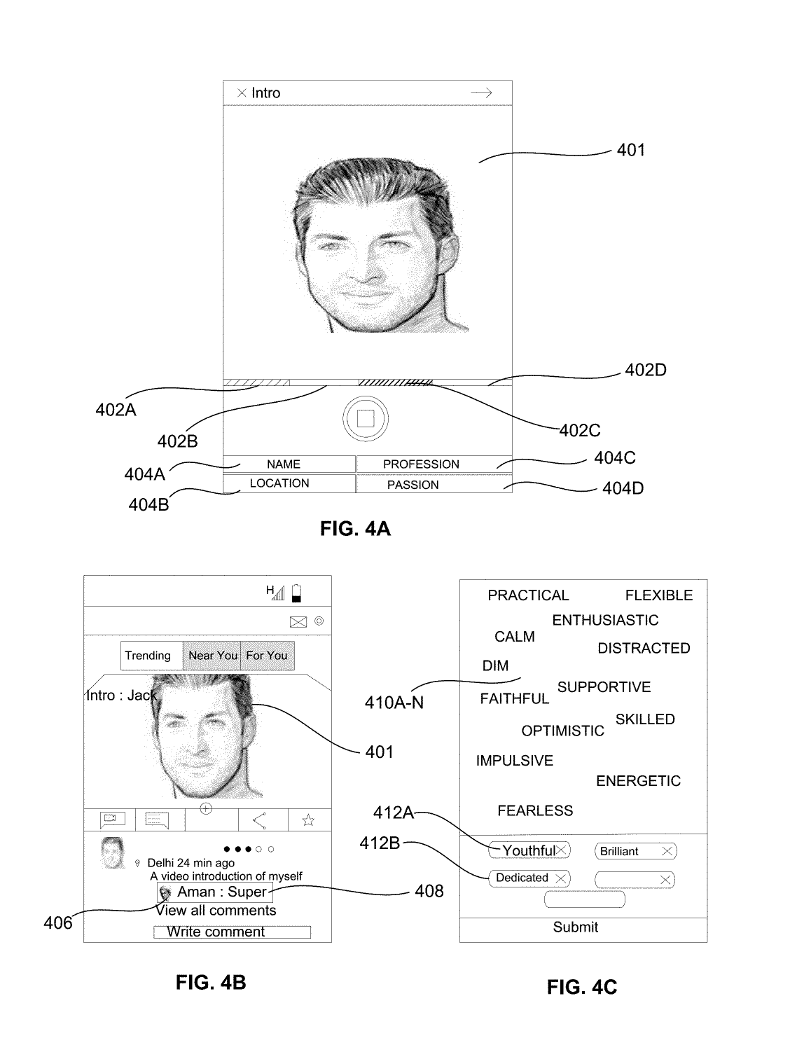

FIG. 4A illustrates a user interface view of the dynamic social vibe creation system 104 of FIG. 1 according to a first embodiment herein. The video 401 is obtained from the user 102. The video 401 includes one or more segments. The video 401 may describes professionalism of the user 102. In one embodiment, the video 401 describes self-introduction of the user 102. The one or more segments include a first segment 402A corresponding to a name segment 404A, a second segment 402B corresponding to a location segment 404B, a third segment 402C corresponding to a profession segment 404C, and a fourth segment 402D corresponding to a passion segment 404D. In one embodiment, the responders 112A-N view at least one of the name segment 404A, the location segment 404B, the profession segment 404C, and the passion segment 404D to comment the responders provided personality related words by selecting at least one of the first segment 402A, the second segment 402B, the third segment 402C, and the fourth segment 402D.

FIG. 4B illustrates a user interface view of the dynamic social vibe creation system 104 of FIG. 1 according to a second embodiment herein. The user interface view includes a responder 406, and a responder provided personality related word 408. The responder 406 may comment their personality related word 408 for the video 401 of the user 102. In one embodiment, the responder 406 may select the responders provided personality related word 408 from the appraised personality related words that are appraised by the appraisers 110A-N. In another embodiment, the responder 406 may provide his/her own chosen words. In another embodiment, each of the chosen words is appraised in the appraisal server 108 by the appraisers 110A-N to obtain the appraised personality related words.

FIG. 4C illustrates a user interface view of the dynamic social vibe creation system 104 of FIG. 1 according to a third embodiment herein. The user interface view depicts that the responders 112A-N may select their personality related words 412A-B for the video 401 of the user 102 from the appraised personality related words 410A-N. In one embodiment, the responders may select at least one personality related words 412 from the appraised personality related words 410A-N.

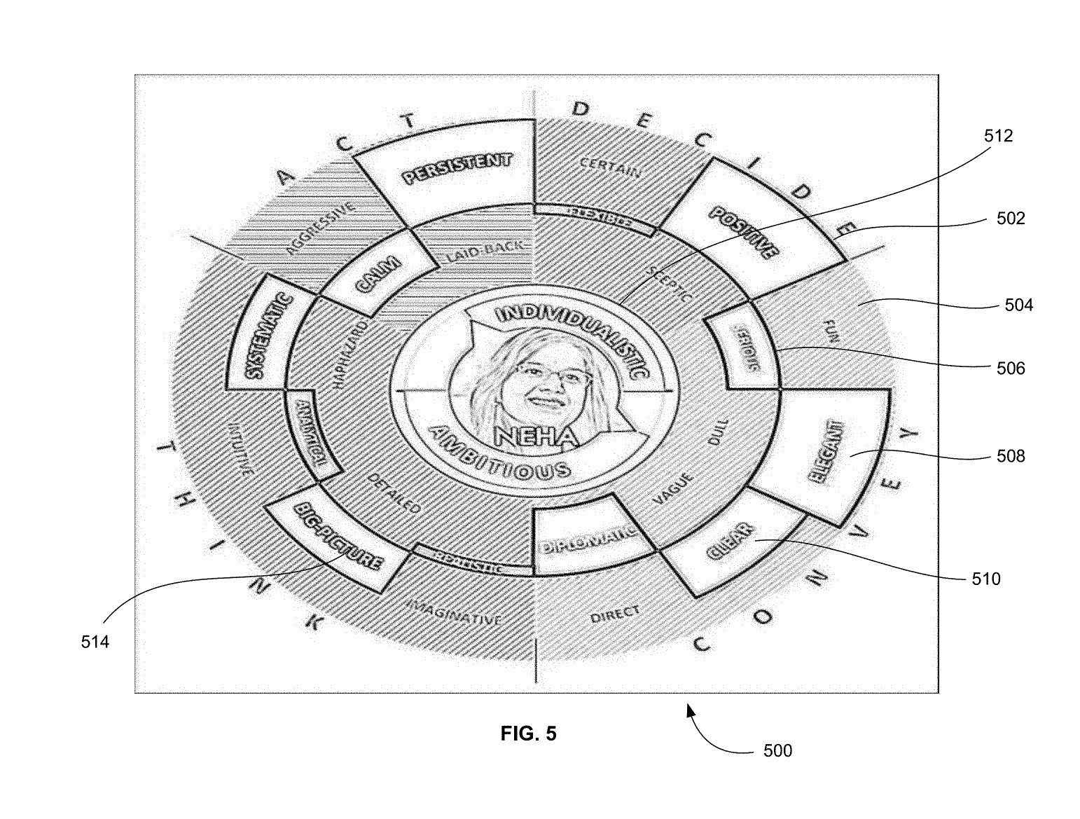

FIG. 5 illustrates a user interface view of the dynamic social vibe 106 of FIG. 1 according to an embodiment herein. The user interface view describes the dynamic social vibe 500 of the user 102. In the dynamic social vibe 500, (i) a central annulus 512 depicts the predefined dimensions corresponding to two personality choice dimensions, (ii) a middle annulus 506 depicts the predefined dimensions corresponding to twelve personality style dimensions, and iii) an outer annulus 502 depicts the predefined dimensions corresponding to four capability personality dimensions. In one embodiment, each of the two personality choice dimensions is expressed as a speedometer with a smaller angled sector that describes a smaller value on a particular personality dimension (e.g. a choice dimension, a style dimension, and a capability dimension). In one embodiment, each of the twelve personality style dimensions is expressed as a circular graphic equalizer or a radar chart. In another embodiment, values of each of the twelve personality style dimensions are mapped as a size of radius of the dynamic social vibe 500 of the user 102. A large radius value displays a higher value on the particular personality dimension. In another embodiment, a width of a sector (e.g., 504, 508, 510, and 514) depicts the range of values that the user 102 has on the particular personality dimension (e.g. a choice dimension, a style dimension, and a capability dimension).

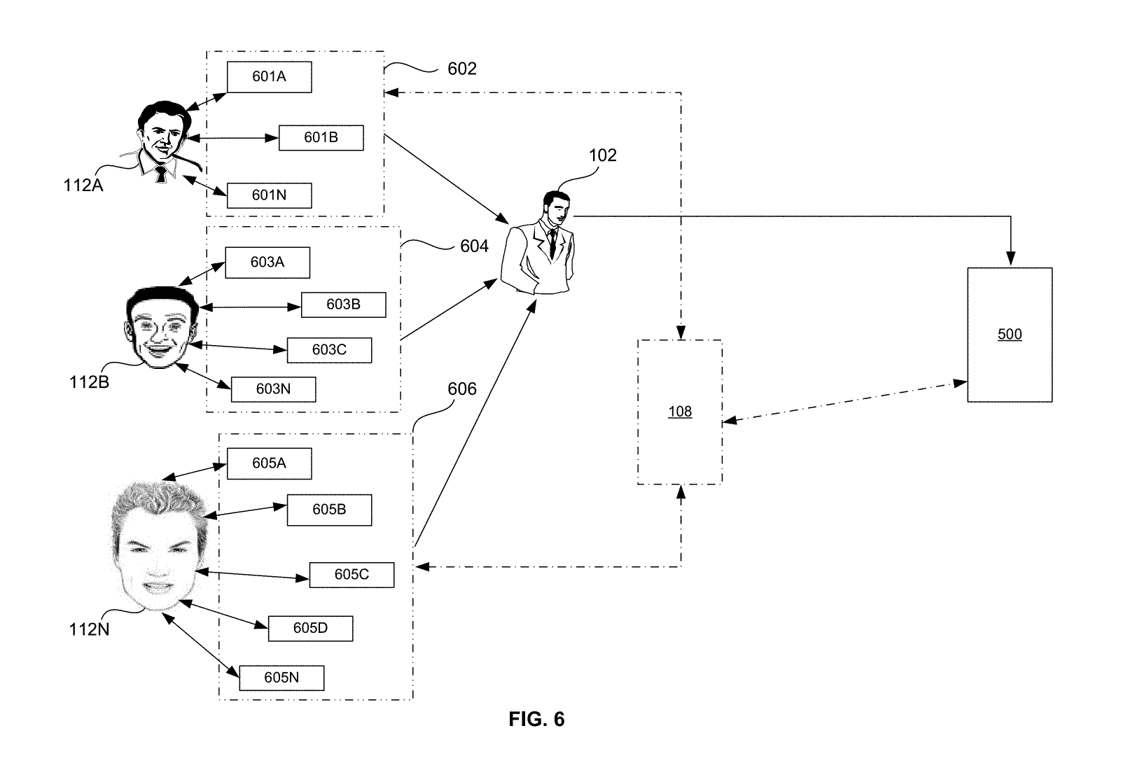

FIG. 6 illustrates an exemplary view of the dynamic social vibe creation system 104 of FIG. 1 according to an embodiment herein. The exemplary view depicts, the responders 112A-N gives their personality related words to the user 102 for a video. In one embodiment, each of the responders 112A-N may respond one or more times to the video of the user 102. For example, (i) the responder 112A responded three times (e.g. 601A, 601B, and 601N), (ii) the responder 112B responded four times (e.g. 603A, 603B, and 603N), and (iii) the responder 112C responded five times (e.g. 605A, 605B, and 605N) to the video of the user 102. Each of the responses (e.g. 601A, 601B, and 601N) includes one or more number of personality related words provided the responders 112A. The dynamic social vibe creation system 104 obtains each of the responses (e.g. 601A, 601B, and 601N) to create the dynamic social vibe 500 of the user 102. In one embodiment, the appraisal server 108 assigns a weightage to each of the responses (e.g. 601A, 601B, and 601N) of the responders 112A-N. In one embodiment, the weightage may be assigned to equal number of the responder provided personality related words (e.g. 5). The appraisal server 108 selects top most personality related words (e.g. 602, 604, and 606) provided by the responder 112A-N for each of the responders 112A-N based on the weightage. The appraisal server 108 analyzes each of personality related words provided by the responders 112A-N to determine an union across the predefined dimensions for each of the responder provided personality related words. In one embodiment, the appraisal server 108 creates the dynamic social vibe 500 based on the union.

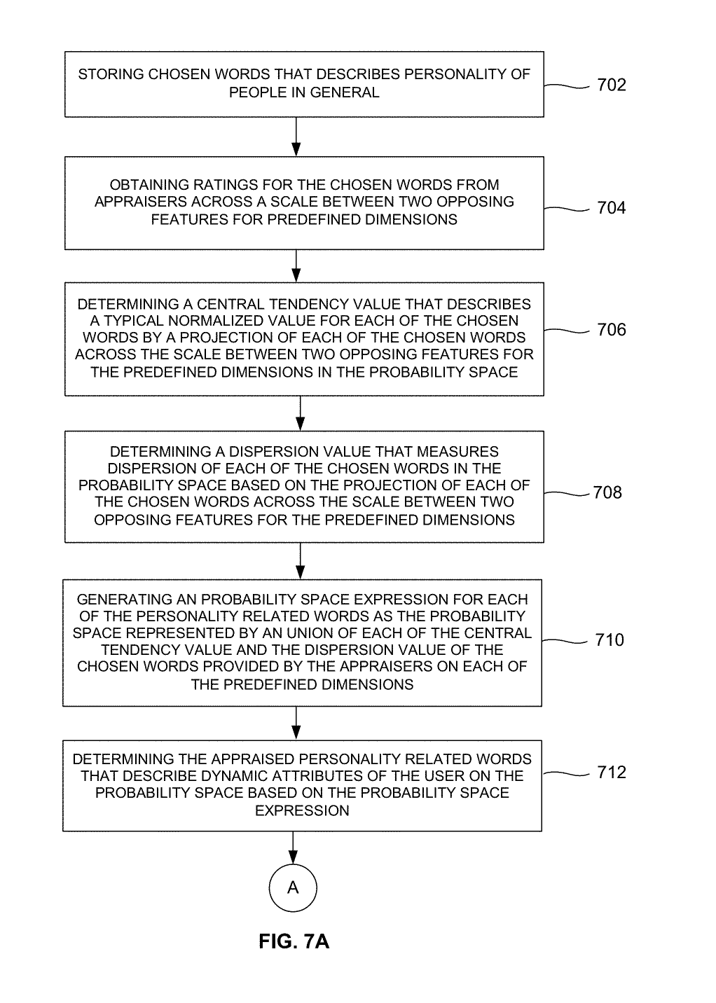

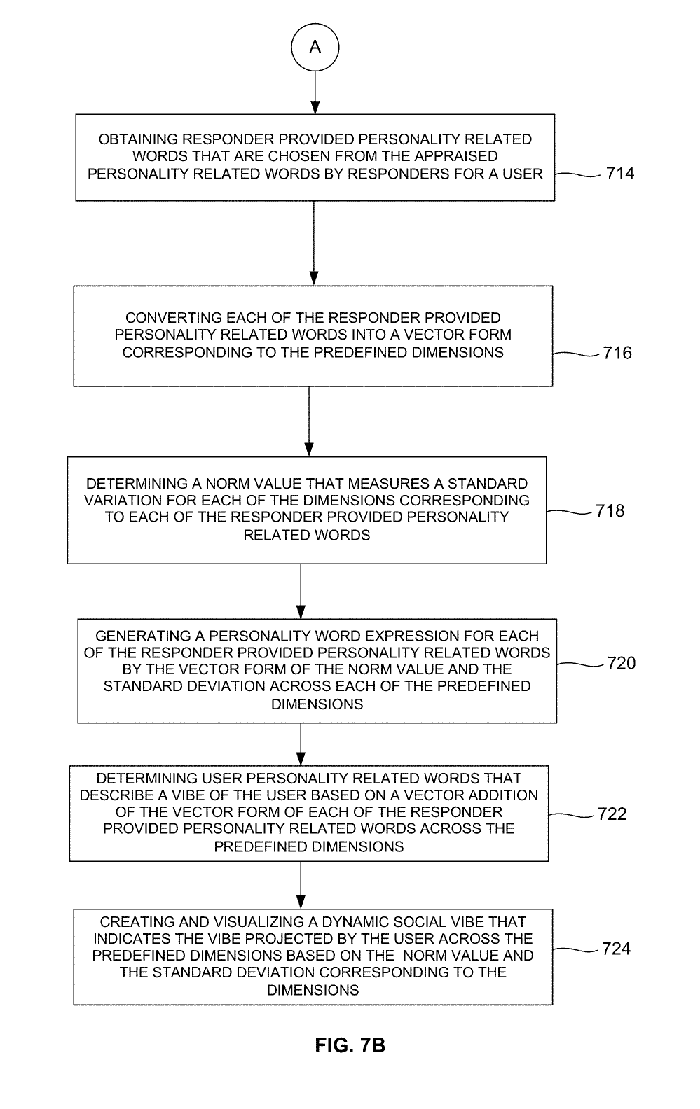

FIGS. 7A and 7B are flow diagrams that illustrate a method of determining the dynamic social vibe of the user 102 based on personality related words attributed to the user 102 by the responders 112A-N of FIG. 1 according to an embodiment herein. At step 702, the appraisal server 108 stores the chosen words that describes personality of people in general. At step 704, the appraisal server 108 obtains ratings for the chosen words from the appraisers 110A-N across the scale between two opposing features for the predefined dimensions. At step 706, the appraisal server 108 determines a central tendency value that describes a typical normalized value for each of the chosen words by a projection of each of the chosen words across the scale between the two opposing features for the predefined dimensions in the probability space. At step 708, the appraisal server 108 determines a dispersion value that measures dispersion of each of the chosen words in the probability space based on the projection of each of the chosen words across the scale between the two opposing features for the predefined dimensions. At step 710, the appraisal server 108 generates a probability space expression for each of the personality related words as the probability space represented by union of each of the central tendency value and the dispersion value of the chosen words provided by the appraisers 110A-N on each of the predefined dimensions. At step 712, the appraisal server 108 determines the appraised personality related words that describe dynamic attributes of the user 102 on the probability space based on the probability space expression.

At step 714, the dynamic social vibe creation system 104 obtains responder provided personality related words that are chosen from the appraised personality related words by the responders 112A-N for the user 102. At step 716, the dynamic social vibe creation system 104 converts each of the responder provided personality related words into a vector form corresponding to the predefined dimensions. At step 718, the dynamic social vibe creation system 104 determines a norm value that measures a standard variation for each of the predefined dimensions corresponding to each of the responder provided personality related words. At step 720, the dynamic social vibe creation system 104 generates a personality expression for each of the responder provided personality related words by the vector form of the norm value and the standard deviation across each of the predefined dimensions corresponding to each of the responder provided personality related words. At step 722, the dynamic social vibe creation system 104 determines user personality related words that describe a vibe of the user 102 based on a vector addition of the vector form of each of the responder provided personality related words across the predefined dimensions. At step 724, the dynamic social vibe creation system 104 creates and visualizes the dynamic social vibe 500 that indicates the vibe projected by the user 102 across the predefined dimensions based on the norm value and the standard deviation corresponding to the predefined dimensions.

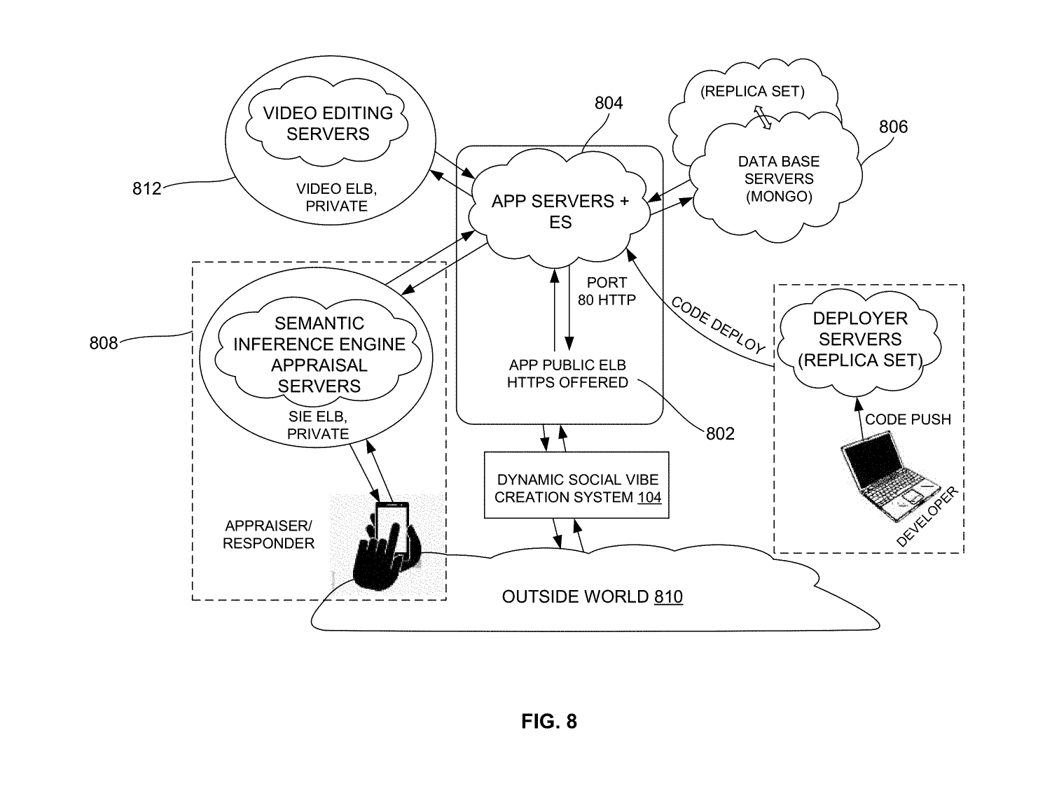

FIG. 8 illustrates a system view of overall technical and cloud architecture of the appraisal, video editing and app servers that are used to determine and publish the dynamic social vibe of FIG. 1 according to the embodiments herein. Request comes to the dynamic social vibe creation system 104. The dynamic social vibe creation system 104 sends the request to public Elastic Load Balancer (ELB) 802. The public ELB 802 decides which App-server to pass the request to. Request lands on chosen App-server 804 based on request it decided to hit: (a) Port 2:7017—Database Server 806 having non structured query based on database (e.g. Mongo); (b) Port 80—Connect with the words-dimensions mapping at the Semantic Inference Engine (SIE) appraisal ELB 808. The appraisers 110A-N and the responders 112A-N in the outside world 810 also access the SIE ELB 808 using mobile apps. (c) Port 8080—Connect with video editing servers 812 for sending raw videos, text, styles, filters and receiving final edited videos.

The dynamic social vibe creation system 104 may include several applications assessing personalities, job functions, travel locations, and the like. The dynamic social vibe creation system 104 may reduce the dispersion in measuring personality of any person. The dynamic social vibe 500 defines how you (e.g. the user 102) are viewed by the world (e.g. the responders 112A-N) and avoids false precision. The dynamic social vibe creation system 104 provides a systematic method to capture meanings of words (e.g. the responders provided personality words) in a social context and converts people (e.g. the responders 112A-N) impressions about each other in a measurable way to obtain personality of the user 102.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method for determining a dynamic social vibe of a user based on personality related words attributed to the user by responders, comprising
(a) accessing a probability space of appraised personality related words, wherein the appraised personality related words are created by an appraisal process comprising
storing chosen words that describes personality of people in general;
obtaining ratings for the chosen words from appraisers across a scale between two opposing features for predefined dimensions;
determining a central tendency value that describes a typical normalized value for each of the chosen words by a projection of each of the chosen words across the scale between two opposing features for the predefined dimensions in the probability space;
determining a dispersion value that measures dispersion of each of the chosen words in the probability space based on the projection of each of the chosen words across the scale between two opposing features for the predefined dimensions;
generating a probability space expression for each of the personality related words as the probability space represented by an union of each of the central tendency value and the dispersion value of the chosen words provided by the appraisers on each of the predefined dimensions; and
determining the appraised personality related words that describe dynamic attributes of the user on the probability space based on the probability space expression;
(b) obtaining responder provided personality related words that are chosen from the appraised personality related words by the responders for the user;
(c) determining the dynamic social vibe of the user by a vibe process comprising
converting each of the responder provided personality related words into a vector form corresponding to the predefined dimensions;
determining a norm value that measures a standard variation for each of the dimensions corresponding to each of the responder provided personality related words;
generating a personality expression for each of the responder provided personality related words by the vector form of the norm value and the standard deviation across each of the predefined dimensions;
determining user personality related words that describe a vibe of the user based on a vector addition of the vector form of each of the responder provided personality related words across the predefined dimensions; and
creating and visualizing the dynamic social vibe that indicates the vibe projected by the user across the predefined dimensions based on the norm value and the standard deviation corresponding to the predefined dimensions.

2. The method of claim 1, wherein the appraisal process of creating the appraised personality related words further comprises
determining an actual meaning for each of the chosen words in many countries based on a cultural factor;
determining a contextual meaning for each of the chosen words based on a contextual factor;
determining a metaphorical expression for each of the chosen words based on a metaphorical factor; and
determining an expansiveness meaning for each of the chosen words based on an expansiveness factor.

3. The method of claim 2, wherein the appraisal process of creating the appraised personality related words further comprises
assigning a predefined weightage to each of the responder provided personality related words to ensure that each of the responders have an equal weightage corresponding to their responses with reference to the user.

4. The method of claim 1, obtaining a video of the user, wherein the video comprises a segment selected from at least one of (i) a profession segment or (v) a passion segment, wherein the predefined dimensions are selected from at least one of (i) a choice dimension, (ii) a style dimension, or (iii) a capability dimension.

5. The method of claim 4, wherein the vibe process of the dynamic social vibe comprises
reducing (i) variances by increasing a number of attempts of responses provided by the responders, and (ii) opposing feedbacks received from the responders for the video about the user.

6. The method of claim 5, wherein the vibe process of the dynamic social vibe comprises
updating the dynamic social vibe automatically when updated each of responder provided personality related words are received from responders.

7. The method of claim 6, wherein the obtaining of the responder provided personality related words from the responders comprises
verifying a relationship between the user and each of the responders to filter high values of the responder provided personality related words to the user.

8. A dynamic social vibe creation tool that determines a dynamic social vibe of a user based on personality related words attributed to the user by responders, comprising
a first memory that stores a first database and a first set of modules; and
a first processor that executes the first set of modules, wherein the first set of modules comprises
a probability space accessing module that accesses a probability space of appraised personality related words, wherein the appraised personality related words are created by an appraisal process, wherein the probability space accessing module comprises
a chosen words storing module that stores chosen words that describes personality of people in general;
an appraisers ratings obtaining module that obtains ratings for the chosen words from appraisers across a scale between two opposing features for predefined dimensions;
a central tendency value determination module that determines a central tendency value that describes a typical normalized value for each of the chosen words by a projection of each of the chosen words across the scale between two opposing features for the predefined dimensions in the probability space;
a dispersion value determination module that determines a dispersion value that measures dispersion of each of the chosen words in the probability space based on the projection of each of the chosen words across the scale between two opposing features for the predefined dimensions;
a probability space expression generating module that generates a probability space expression for each of the personality related words as the probability space represented by an union of each of the central tendency value and the dispersion value of the chosen words provided by the appraisers on each of the predefined dimensions; and
an appraised words determination module that determines the appraised personality related words that describe dynamic attributes of the user on the probability space based on the probability space expression;
a respondent responses obtaining module that obtains responder provided personality related words that are chosen from the appraised personality related words by the responders for the user;
a dynamic social vibe determination module that determines the dynamic social vibe of the user by a vibe process, wherein the dynamic social vibe determination module comprises
a vector form converting module that converts each of the responder provided personality related words into a vector form corresponding to the predefined dimensions;
a norm value determination module that determines a norm value that measures a standard variation for each of the dimensions corresponding to each of the responder provided personality related words;
a personality expression generating module that generates a personality expression for each of the responder provided personality related words by the vector form of the norm value and the standard deviation across each of the predefined dimensions;
an user personality related words determination module that determines user personality related words that describe a vibe of the user based on a vector addition of the vector form of each of the responder provided personality related words across the predefined dimensions; and
a dynamic social vibe creation module that creates and visualizes the dynamic social vibe that indicates the vibe projected by the user across the predefined dimensions based on the norm value and the standard deviation corresponding to the predefined dimensions.

9. The dynamic social vibe creation tool of claim 8, wherein the probability space accessing module further comprises
an actual meaning of word determination module, implemented by the first processor, that determines an actual meaning for each of the chosen words in many countries based on the cultural factor;
a context meaning of word determination module, implemented by the first processor, that determines a context meaning for each of the chosen words based on the context factor;
a metaphorical meaning of word determination module, implemented by the first processor, that determines a metaphorical expression for each of the chosen words based on the metaphorical factor; and
an expansiveness meaning of word determination module, implemented by the first processor, that determines an expansiveness meaning for each of the chosen words based on the expansiveness factor.

10. The dynamic social vibe creation tool of claim 9, wherein the probability space accessing module further comprises
a predefined weightage assignment module, implemented by the first processor, that assigns predefined weightage to each of the responder provided personality related words to ensure each of the responders have an equal weightage corresponding to them responses for the user.

11. The dynamic social vibe creation tool of claim 10, wherein the dynamic social vibe determination module further comprises a video obtaining module that obtains a video of the user, wherein the video comprises many segments, wherein the segments comprises at least one of (i) a profession segment or (v) a passion segment, wherein the predefined dimensions comprises (i) at least one choice dimension, (ii) at least one style dimension, and (iii) at least one capability dimension.

12. The dynamic social vibe creation tool of claim 11, wherein the dynamic social vibe determination module further comprises
a variances identifying module that identifies many variances corresponding to the expression for each of the responder provided personality related words in the probability space; and
a variances eliminating module that eliminates (i) the many variances by increasing more attempts of the expression, and (ii) opposing feedbacks received from the responders for the video about the user.

13. The dynamic social vibe creation tool of claim 12, wherein the dynamic social vibe determination module further comprises a dynamic social vibe updating module that updates the dynamic social vibe chart automatically when each of responder provided personality related words is newly received from the responders.

14. The dynamic social vibe creation tool of claim 13, wherein the dynamic social vibe determination module further comprises a relationship verification module that verifies relationship between the user and each of the responders to filter the responder provided personality related words to the user.

15. One or more non-transitory computer readable storage mediums storing one or more sequences of instructions, which when executed by one or more processors, causes determination of a dynamic social vibe of a user based on personality related words attributed to the user by responders, comprising
(a) accessing a probability space of appraised personality related words, wherein the appraised personality related words are created by an appraisal process comprising
storing chosen words that describes personality of people in general;
obtaining ratings for the chosen words from appraisers across a scale between two opposing features for predefined dimensions;
determining a central tendency value that describes a typical normalized value for each of the chosen words by a projection of each of the chosen words across the scale between two opposing features for the predefined dimensions in the probability space;
determining a dispersion value that measures dispersion of each of the chosen words in the probability space based on the projection of each of the chosen words across the scale between two opposing features for the predefined dimensions;
generating a probability space expression for each of the personality related words as the probability space represented by an union of each of the central tendency value and the dispersion value of the chosen words provided by the appraisers on each of the predefined dimensions; and
determining the appraised personality related words that describe dynamic attributes of the user on the probability space based on the probability space expression;
(b) obtaining responder provided personality related words that are chosen from the appraised personality related words by the responders for the user;
(c) determining the dynamic social vibe of the user by a vibe process comprising
converting each of the responder provided personality related words into a vector form corresponding to the predefined dimensions;
determining a norm value that measures a standard variation for each of the dimensions corresponding to each of the responder provided personality related words;
generating a personality expression for each of the responder provided personality related words by the vector form of the norm value and the standard deviation across each of the dimensions;
determining user personality related words that describe a vibe of the user based on a vector addition of the vector form of each of the responder provided personality related words across the predefined dimensions; and
creating and visualizing the dynamic social vibe that indicates the vibe projected by the user across the predefined dimensions based on the norm value and the standard deviation corresponding to the predefined dimensions.

16. The one or more non-transitory computer readable storage mediums storing one or more sequences of instructions of claim 15, wherein the appraisal process of creating the appraised personality related words further causes
determining an actual meaning for each of the chosen words in many countries based on the cultural factor;
determining a context meaning for each of the chosen words based on the context factor;
determining a metaphorical expression for each of the chosen words based on the metaphorical factor; and
determining an expansiveness meaning for each of the chosen words based on the expansiveness factor.

17. The one or more non-transitory computer readable storage mediums storing one or more sequences of instructions of claim 16, wherein the appraisal process of creating the appraised personality related words further causes
assigning predefined weightage to each of the responder provided personality related words to ensure each of the responders have an equal weightage corresponding to them responses for the user.

18. The one or more non-transitory computer readable storage mediums storing one or more sequences of instructions of claim 17, wherein the vibe process of the dynamic social vibe further causes obtaining a video of the user, wherein the video comprises many segments, wherein the segments comprises at least one of (i) a profession segment or (v) a passion segment, wherein the predefined dimensions comprises (i) at least one choice dimension, (ii) at least one style dimension, and (iii) at least one capability dimension.

19. The one or more non-transitory computer readable storage mediums storing one or more sequences of instructions of claim 18, wherein the vibe process of the dynamic social vibe comprises
identifying many variances corresponding to the expression for each of the responder provided personality related words in the probability space;
eliminating (i) the many variances by increasing more attempts of the expression, and (ii) opposing feedbacks received from the responders for the video about the user; and
updating the dynamic social vibe chart automatically when each of responder provided personality related words is newly received from the responders.

20. The one or more non-transitory computer readable storage mediums storing one or more sequences of instructions of claim 19, wherein the obtaining of the responder provided personality related words from the responders comprises
verifying a relationship between the user and each of the responders to filter the responder provided personality related words to the user.
